(19) United States
(12) Patent Application Publication
(10) Pub. No.: US 2008/0272164 A1
(43) Pub. Date: Nov. 6, 2008

(54) Roof rack for vehicles

(76) Inventor: Chiu-Kuei Wang, Dajia Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,282

(22) Filed: Mar. 4, 2008

(30) Foreign Application Priority Data
May 3, 2007 (TW) 096207073

(51) Int. Cl. B60R 9/058

(52) U.S. Cl. 224/330

(57) ABSTRACT

A roof rack includes a basket which is assembled by a top portion and a bottom portion which is connected to an underside of the top portion so as to form the basket with tapered sidewalls. The tapered sidewalls securely engage a storage box with tapered outer profile so that the storage box can be engaged with the basket without using ropes. The basket can be assembled by multiple sub-top portions and sub-bottom portions.

### FIELD OF THE INVENTION

The present invention relates to a roof rack for vehicles and the storage box is securely engaged with the roof rack without using ropes.

### BACKGROUND OF THE INVENTION

A conventional roof rack “C” is shown in FIGS. 9A and 9B, and which is generally a basket 61 composed of a top rail 62, a bottom rail 63 and a plurality of altitude and latitude rods 611, 612 connected between the top and bottom rails 62, 63. The basket 61 is made to be three parts which are connected to each other, and the assembled basked 61 is then secured on the roof of the vehicle 50 by multiple connection members 51. It is noted that the basket 61 includes four substantially vertical side walls so that when a storage box or luggage is secured to the basket 61, ropes are needed to tie the luggage to the basket 61. The ropes are easily loosened due to vibration when ridding on a rugged road and the luggage may drop from the basket 61. Furthermore, the connection members 51 could loose and the three parts of the basket 61 generate noise.

The present invention intends to provide a roof rack which includes a tapered side walls so that the storage box can be securely engaged with the roof rack and no ropes are needed.

### SUMMARY OF THE INVENTION

The present invention relates to a roof rack for vehicles and the roof rack is a basket comprising a top portion and a bottom portion which is connected to an underside of the top portion so as to form the basket with tapered sidewalls.

The primary object of the present invention is to provide a roof rack for vehicles and the roof rack includes tapered sidewalls so as to securely position a storage box with tapered outer profile.

Another object of the present invention is to provide a roof rack for vehicles wherein the storage box can be secured to the roof rack without using ropes.

Yet another object of the present invention is to provide a roof rack for vehicles and the roof rack can be assembled by multiple sub-top portions and sub-bottom portions. Connection members are used to connect the adjacent sub-top portions and sub-bottom portions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the roof rack of the present invention;

FIG. 1A is a top view to show the roof rack of the present invention;

FIG. 2 is a perspective view to show a second embodiment of the roof rack of the present invention;

FIG. 3 is an exploded view to show the second embodiment of the roof rack of the present invention;

FIG. 3A shows a storage box is engaged with the tapered sidewalls of the roof rack of the present invention;

FIG. 3B is a side view of the status in FIG. 3A;

FIG. 4 shows an exploded view of the fixing unit and the connection member;

FIG. 5 shows an exploded view of the fixing part for connecting the roof rack to the roof of vehicles;

FIG. 6 is an exploded view to show the third embodiment of the roof rack of the present invention;

FIG. 7 shows the fourth embodiment of the roof rack and a storage box;

FIG. 7A shows a cross sectional view to show the engagement of the storage box and the storage box in FIG. 7;

FIG. 7B shows a cross sectional view from another angle to show the engagement of the storage box and the storage box in FIG. 7;

FIG. 8 shows that the roof rack is fixed on a roof of a vehicle and a storage box is engaged with the roof rack;

FIG. 9A is an exploded view of a conventional roof rack, and

FIG. 9B shows that the conventional roof rack is installed on a roof of a vehicle.

### DETAILED DESCRIPTION OF THE PREFERRED EMBODIMENT

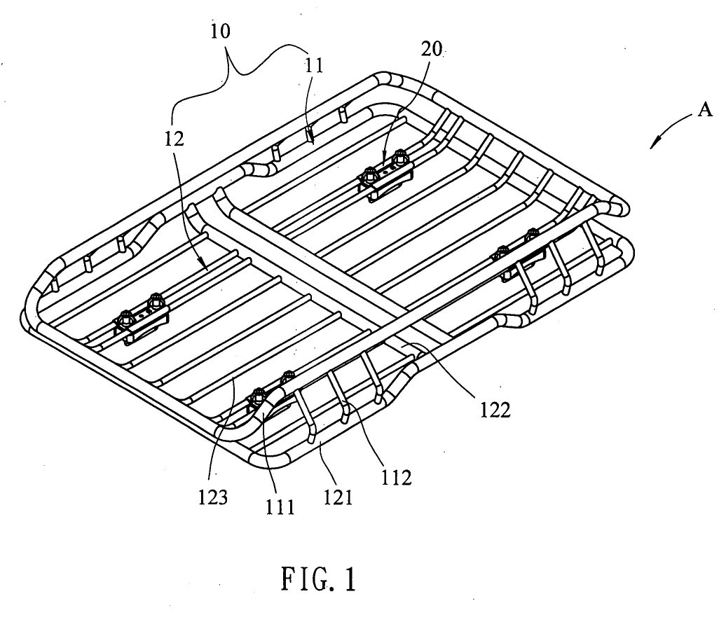

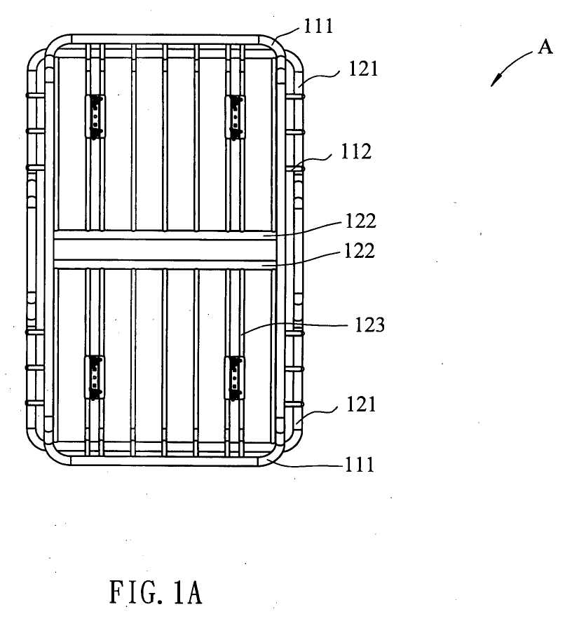

Referring to FIGS. 1, and 1A, the roof rack “A” of the present invention is a basket 10 which is composed of a top portion 11 and a bottom portion 12 which is connected to an underside of the top portion 11 so as to form the basket 10 with tapered sidewalls. The bottom portion 12 includes a substantially rectangular bottom rail 121, a plurality of first links 122 and second links 123 which are connected to the first links 122 crossly, respective tops of the first links 122 and the second links 123 are connected to the bottom rail 121. The top portion 11 includes a plurality of third links 112 which are connected a top rail 11 and the bottom rail 121. The second links 123 include two upward inclined ends at joints of the second links 123 and the bottom rail 121, distal ends of the upward inclined ends are connected to the top rail 111 so as to form the tapered sidewalls.

In this embodiment, the bottom portion 12 is a substantially rectangular frame and includes two first links 122 connected between two opposite sides of the bottom rail 121 and the second links 123 are perpendicularly connected between the first links 122 and the other two opposite sides of the bottom rail 121. The top portion 11 is a substantially rectangular frame which is connected to the bottom rail 12 by the third links 112 and the second links 123. The top rail 111, the bottom rail 121 and the first links 122 have the same size which is twice of the size of the second links 123 and the third links 112.

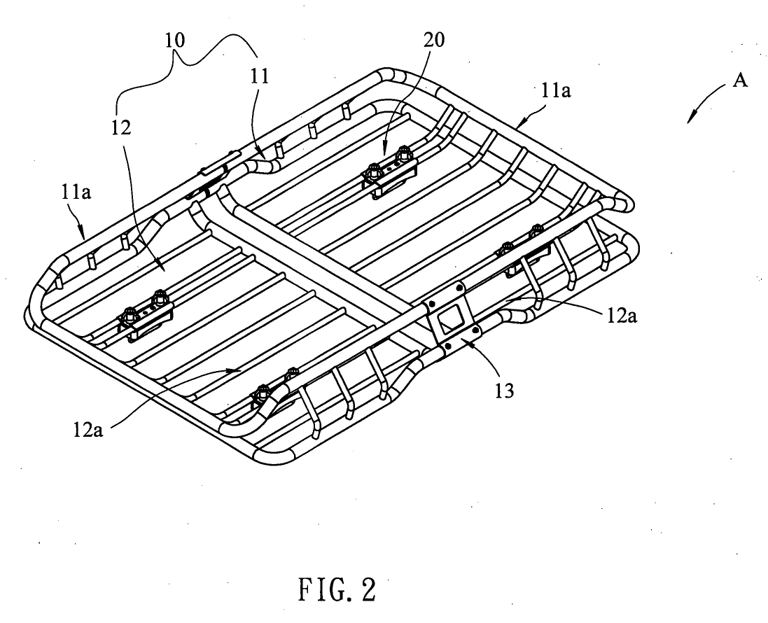

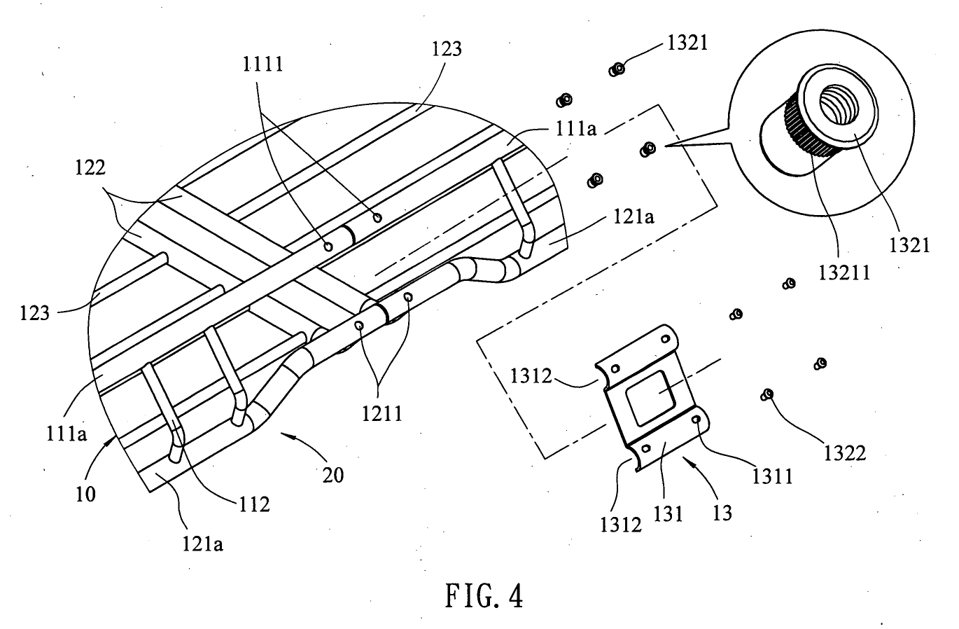

Referring to FIGS. 2, 3, 3A, 3B and 4, the basket 10 can be composed of multiple parts, wherein the top portion 11 is composed of multiple sub-top portions 11a and the bottom portion 12 is composed of multiple sub-bottom portions 12a. The top rail 111 is composed of multiple sub-top rails 111a and the bottom rail 121 is composed of multiple sub-bottom rails 121a, a plurality of connection members 13 connect between the sub-top rails 111a and the sub-bottom rails 121a to form the roof rack “A”.

The connection members 13 each include a connection plate 131 and multiple fixing units 132, wherein the connection plate 131 includes two recesses 1312 on two sides thereof and the sub-top rails 111a and the sub-bottom rails 121a are engaged with the recesses 1312. The fixing units 132 connect the connection plate 131 to the sub-top rails 111a and the sub-bottom rails 121a. Each fixing unit 132 includes a nut 1321 and a bolt 1322. Each of the connection plates 13 includes apertures 1311 defined therethrough and located to communicate with the recesses 1312. Each of the sub-top rails 111a and the sub-bottom rails 121a includes through holes 1111, 1211, the bolts 1322 extend through the apertures 1311, the through holes 1111, 1211 and are connected to the nuts 1321. Each nut 1321 includes a serrated surface 13211 defined in an outer surface thereof so as to be engaged with the through holes 1111, 1211.

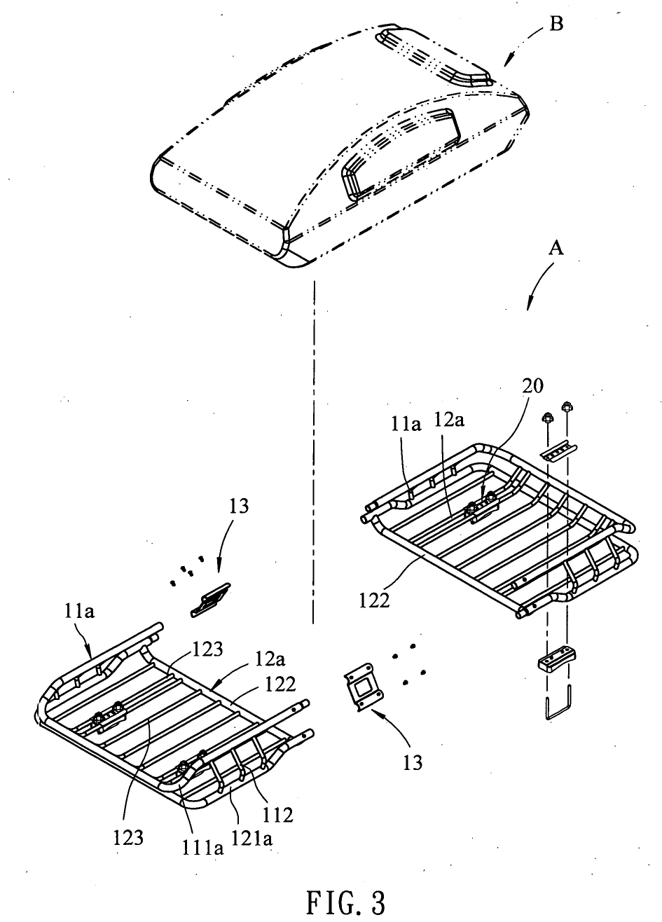

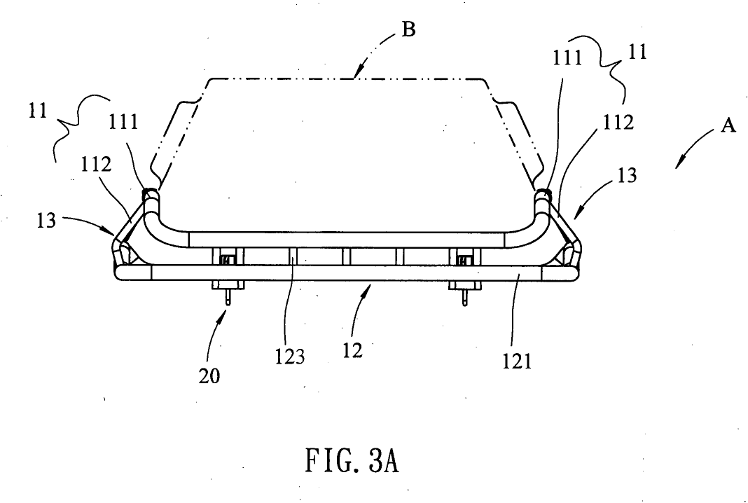

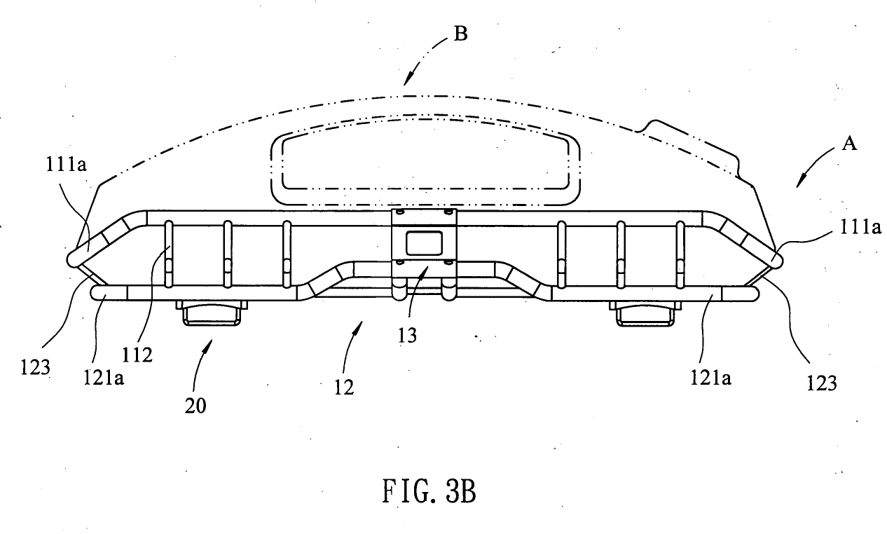

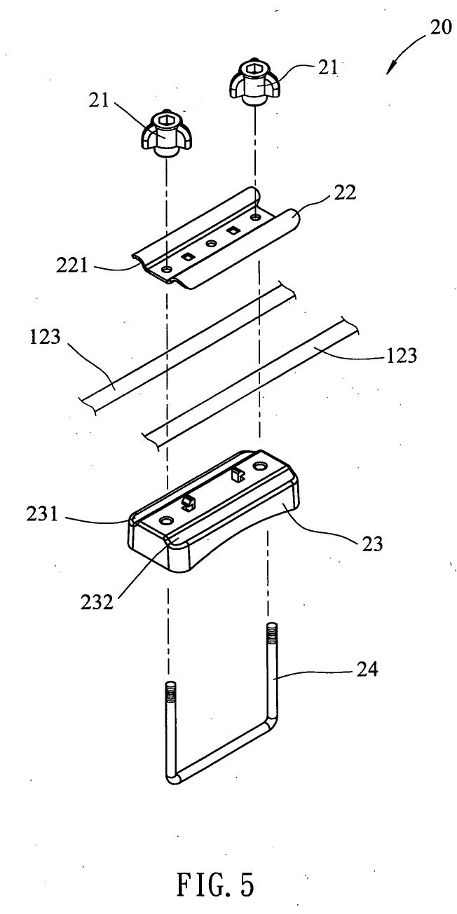

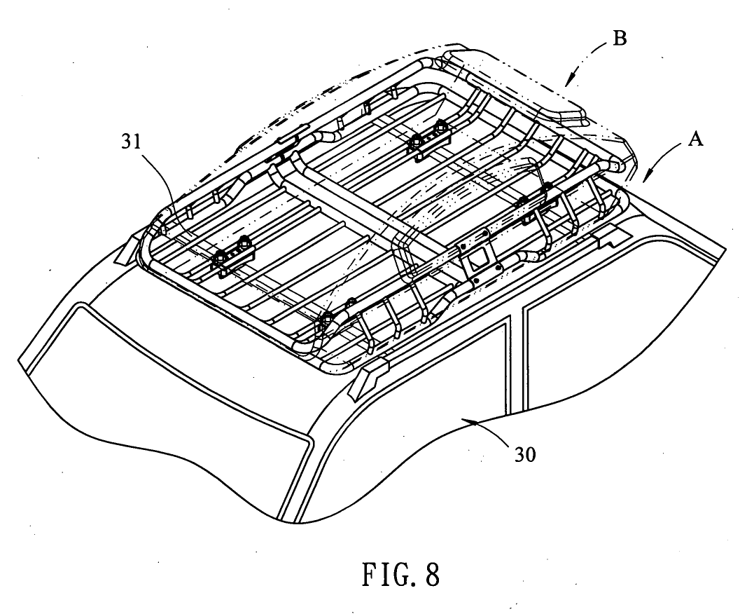

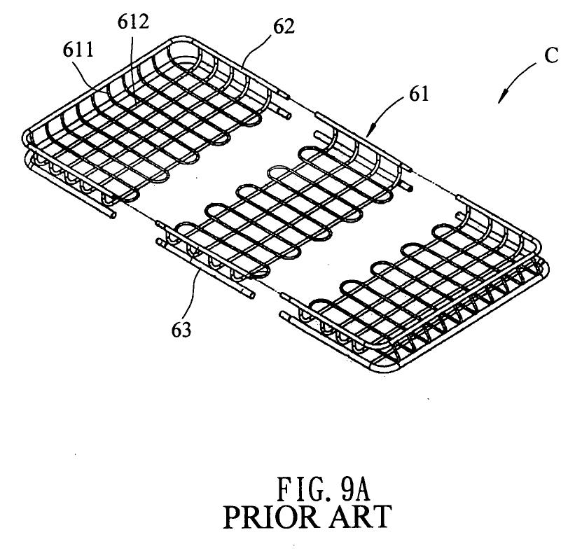

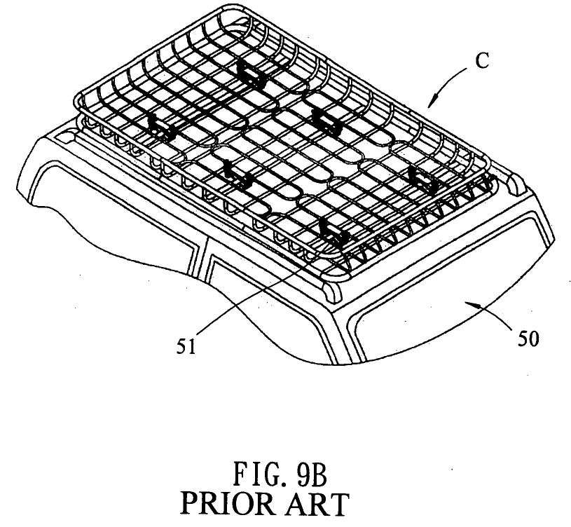

Referring to FIGS. 5 and 8, a plurality of fixing parts 20 each include a pair of nuts 21, a pressing piece 22, a block 23 and a U-shaped rod 24 which extends through a roof 31 of a vehicle 30. The two ends of the U-shaped rod 24 extend through the block 23, the pressing piece 22 and are connected to the pair of nuts 21 to position a pair of the second links 123 between the pressing piece 22 and the block 23. The block 23 and the pressing piece 22 each include a pair of grooves 231, 221, the second links 123 are engaged with the grooves 231, 221. As shown in FIGS. 3A and 3B, a storage box “B” with tapered outer profile can be securely engaged with the roof rack “A” without using ropes.

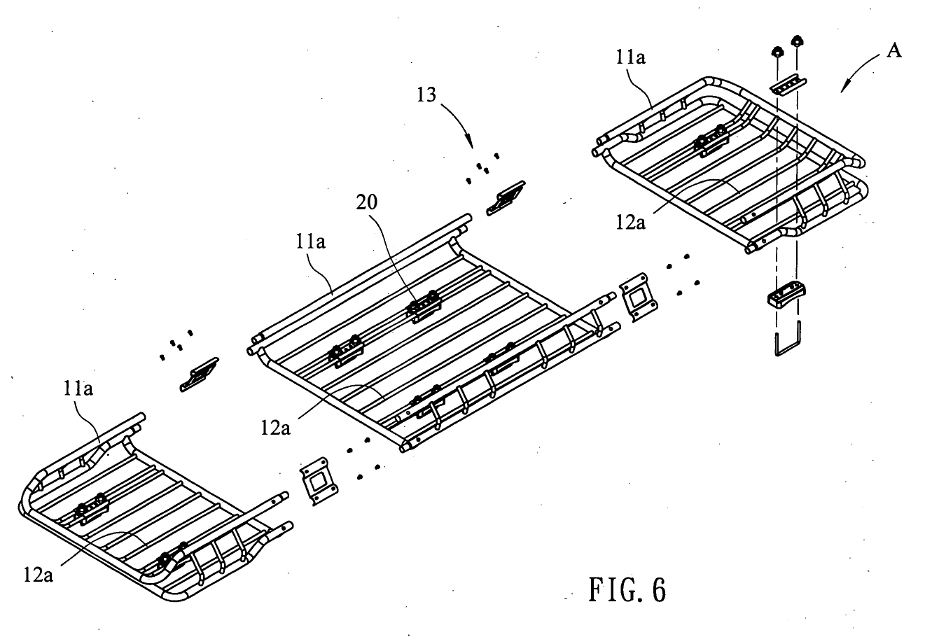

FIG. 6 shows that the roof rack “A” is composed of three parts which are connected to each other by the connection members 13 and fixing units 132.

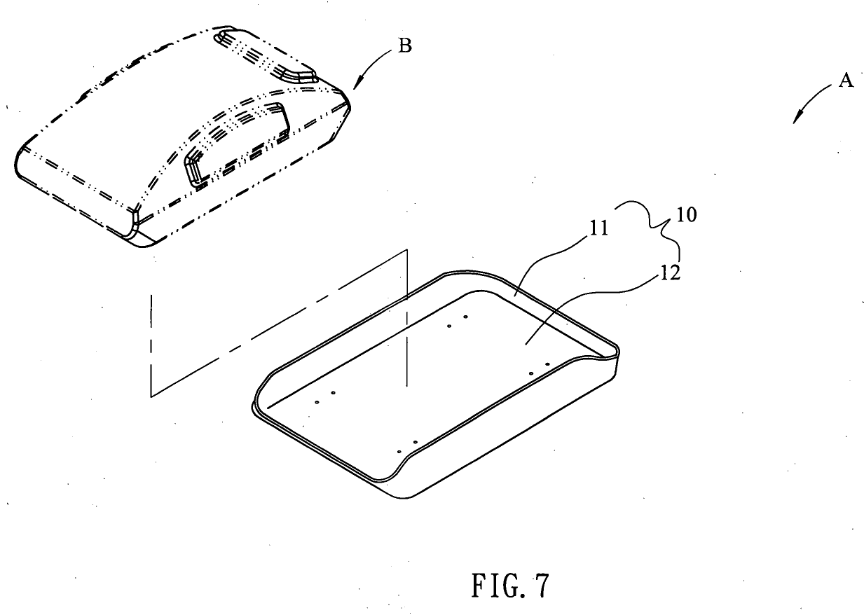

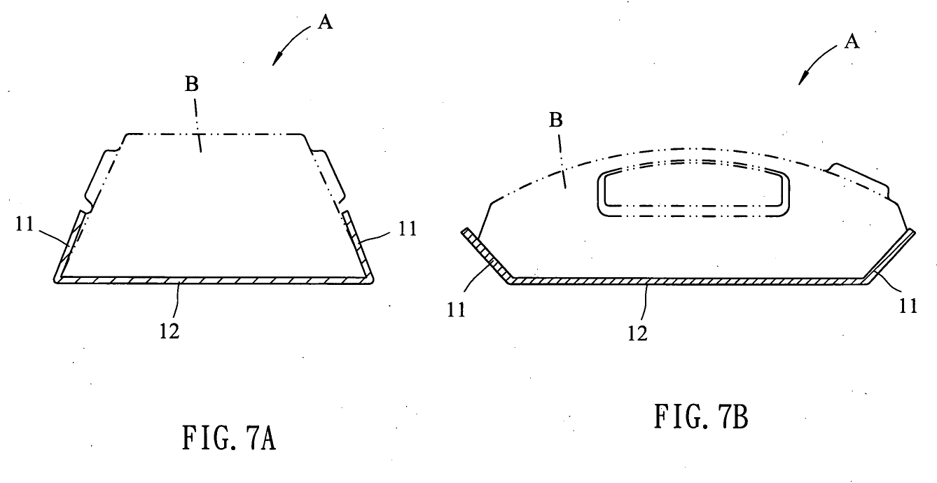

FIGS. 7, 7A and 7B show that the roof rack “A” can also be an integral basket with tapered sidewalls and the storage box “B” can be engaged with the roof rack “A” as shown.

The roof rack “A” can be an integral basket or composed of multiple parts which are connected to each other by connection members 13, the multiple parts make the manufacturers to easily manufacture the parts and to assemble the roof rack “A”. The users can conveniently set the storage box “B” without using ropes and this saves a lot of time.

While we have shown and described the embodiment in accordance with the present invention, it should be clear to those skilled in the art that further embodiments may be made without departing from the scope of the present invention.

What is claimed is:

1. A roof rack comprising:
a basket comprising a top portion and a bottom portion which is connected to an underside of the top portion so as to form the basket with tapered sidewalls.

2. The roof rack as claimed in claim 1, wherein the bottom portion includes a plurality of first links and second links which are connected to the first links crossly, a bottom rail is connected to respective tops of the first links and the second links, the top portion includes a plurality of third links which are connected a top rail and the bottom rail.

3. The roof rack as claimed in claim 2, wherein the second links include two upward inclined ends at joints of the second links and the bottom rail, distal ends of the upward inclined ends are connected to the top rail so as to form the tapered sidewalls.

4. The roof rack as claimed in claim 2, wherein the bottom portion is a substantially rectangular frame and includes two first links connected between two opposite sides of the bottom rail and a plurality of second links are perpendicularly connected between the first links and the other two opposite sides of the bottom rail, the top portion is a substantially rectangular frame which is connected to the bottom rail by the third links and the second links, the top rail, the bottom rail and the first links have the same size which is twice of the size of the second links and the third links.

5. The roof rack as claimed in claim 2, wherein the basket is composed of multiple parts, the top portion is composed of multiple sub-top portions and the bottom portion is composed of multiple sub-bottom portions, the top rail is composed of multiple sub-top rails and the bottom rail is composed of multiple sub-bottom rails, a plurality of connection members connect between the sub-top rails and the sub-bottom rails.

6. The roof rack as claimed in claim 5, wherein each connection member includes a connection plate and multiple fixing units, the connection plate includes two recesses on two sides thereof and the sub-top rails and the sub-bottom rails are engaged with the recesses, the fixing units connect the connection plate to the sub-top rails and the sub-bottom rails.

7. The roof rack as claimed in claim 6, wherein each fixing unit includes a nut and a bolt, each of the sub-top rails and the sub-bottom rails includes through holes, the bolts extend through the through holes and are connected to the nuts, each nut includes a serrated surface defined in an outer surface thereof so as to be engaged with the through holes.

8. The roof rack as claimed in claim 2, wherein a plurality of fixing parts each include a pair of nuts, a pressing piece, a block and a U-shaped rod which is adapted to extend through a roof of a vehicle, the two ends of the U-shaped rod extend through the block, the pressing piece and are connected to the pair of nuts to position a pair of the second links between the pressing piece and the block.

9. The roof rack as claimed in claim 8, wherein the block and the pressing piece each include a pair of grooves, the second links are engaged with the grooves.
